(19) United States
(12) Patent Application Publication
(10) Pub. No.: US 2020/0255604 A1
(43) Pub. Date: Aug. 13, 2020

(54) UNVULCANIZED RUBBER ANTI-TACK AGENT, PRODUCTION METHOD FOR ANTI-TACK LIQUID, AND ANTI-TACK LIQUID PRODUCTION DEVICE

(71) Applicant: Lion Specialty Chemicals Co., Ltd., Tokyo (JP)

(72) Inventors: Kazuyuki SAKAMOTO, Tokyo (JP); Takuya SOGA, Tokyo (JP); Katsuyoshi EBATA, Tokyo (JP); Takao OKA, Tokyo (JP); Kasumi MUKAIDA, Tokyo (JP); Shiro SEHATA, Tokyo (JP)

(73) Assignee: Lion Specialty Chemicals Co., Ltd., Tokyo (JP)

(21) Appl. No.: 16/645,772

(22) PCT Filed: Sep. 10, 2018
(86) PCT No.: PCT/JP2018/033388

§ 371 Date: Mar. 9, 2020

(30) Foreign Application Priority Data
Sep. 11, 2017 (JP) 2017-173885
May 16, 2018 (JP) 2018-094588

(51) Int. Cl. C08J 3/20; C08K 3/34; C08K 3/26; C08L 9/00; C08L 7/00; B01F 15/02; B01F 15/00; B01F 3/12; B01F 7/00

(52) U.S. Cl. CPC C08J 3/203; C08J 2429/04; C08K 3/26; C08L 9/00; C08L 7/00; B01F 15/0235; B01F 15/026; B01F 15/00155; B01F 15/00227; B01F 3/1221; B01F 7/0025; C08K 2003/265; C08J 2307/00; C08J 2309/00; C08J 2401/30; C08K 3/346

(57) ABSTRACT

An anti-tack liquid Q1 is produced by an anti-tack liquid production device, using an anti-tack agent G for unvulcanized rubber in the form of a solid having a moisture content that is more than 3% by mass but is 35% by mass or less, wherein the aforementioned device includes: a hopper 11 for storing the anti-tack agent G for unvulcanized rubber; a stirring tank 13 for mixing water and the anti-tack agent G for unvulcanized rubber; and a quantitative feeder 12 for quantitatively supplying a constant amount of the anti-tack agent for unvulcanized rubber from the hopper 11 to the stirring tank 13.

### TECHNICAL FIELD

The present invention relates to an anti-tack agent for unvulcanized rubber, a method for producing an anti-tack liquid using the same, and an anti-tack liquid production device.

### CROSS-REFERENCE TO RELATED APPLICATIONS

Priority is claimed on Japanese Patent Application No. 2017-173885, filed on Sep. 11, 2017, in Japan, and Japanese Patent Application No. 2018-094588, filed on May 16, 2018, in Japan, the contents of which are incorporated herein by reference.

### BACKGROUND

In the field of production processing of rubber such as natural rubber (NR), butadiene rubber (BR), and styrene butadiene rubber (SBR), unvulcanized rubber molded into a sheet or the like may be stacked or folded for storage until the unvulcanized rubber is used for the next process of molding, vulcanization, and the like.

During such a storage period, for the purpose of preventing the unvulcanized rubber from tightly adhering to each other so that they are not separated, adhering an anti-tack agent (adhesion preventing agent) to the surface of the unvulcanized rubber has been carried out.

In a method for adhering an anti-tack agent to the surface of unvulcanized rubber, first, an anti-tack liquid is prepared by dissolving the anti-tack agent in the form of a powder or liquid in water by means of an independent dissolution device called a dissolution tank. The anti-tack liquid is stored in an immersion tank via a stock tank, and the unvulcanized rubber in a high-temperature state (for example, 80° C. to 150° C.) is immersed in the anti-tack liquid in the immersion tank. Thereby, the anti-tack liquid is adhered to the surface of the unvulcanized rubber. Water in the anti-tack liquid adhered thereto is rapidly evaporated and dried due to the heat of the unvulcanized rubber, and a coating film of the anti-tack agent is formed on the surface of the unvulcanized rubber.

In the immersion tank, evaporation and concentration of the anti-tack liquid occur over time, but the anti-tack liquid in the immersion tank is preferably maintained at a constant amount and in a constant concentration. Conventionally, for example, an operator monitors an immersion tank, adds an anti-tack agent to a dissolution tank as necessary to prepare an anti-tack liquid, and supplies the anti-tack liquid to the immersion tank through a stock tank.

In addition, Patent Document 1 (U.S. Pat. No. 5,288,145) discloses a device which automatically supplies a paste having a high concentration and water to a stirring tank while controlling the concentration.

### SUMMARY

### Technical Problem

In order to reduce transportation costs and storage costs, an anti-tack agent advantageously has a reduced moisture content, and is preferably in the form of a solid, rather than in the form of a liquid or a paste.

However, it is required to prevent the powder from solidifying and to secure fluidity so that an anti-tack agent in the form of a powder in a fixed amount can be supplied to a stirring tank.

The present invention provides an anti-tack agent for unvulcanized rubber which can be supplied in a fixed amount to a stirring tank at the time of producing an anti-tack liquid, and in which transportation costs and storage costs can be reduced, a method for producing an anti-tack liquid using the same, and a device for producing an anti-tack liquid.

### Solution to Problem

The present invention has the aspects described below.

(1) An anti-tack agent for unvulcanized rubber in the form of a solid, having a moisture content that is more than 3% by mass but is 35% by mass or less, and containing: at least one of the following component (A) and the following component (E); and the following component (B),

(A) a smectite,

(B) at least one material selected from the group consisting of inorganic silicates other than the smectite, metal oxides, metal hydroxides, calcium carbonate, red iron oxide, carbon black, graphite, and metallic soaps, and

(E) a water-soluble polymer exhibiting a film-forming ability.

(2) The anti-tack agent for unvulcanized rubber according to (1), which is in the form of a powder, a granule, or a pellet.

(3) The anti-tack agent for unvulcanized rubber according to (1) or (2), wherein a total of the aforementioned component (A) and the aforementioned component (E) is in a range of from 2% by mass to 100% by mass with respect to a total of the aforementioned component (A), the aforementioned component (E), and the aforementioned component (B).

(4) The anti-tack agent for unvulcanized rubber according to any one of (1) to (3), which includes two or more types of compositions and has a total moisture content that is more than 3% by mass but is 35% by mass or less.

(5) The anti-tack agent for unvulcanized rubber according to (4), which includes two or more types of compositions, in which each composition has a moisture content that is more than 3% by mass but is 35% by mass or less.

(6) The anti-tack agent for unvulcanized rubber according to any one of (1) to (5), which is for use in a device for producing an anti-tack liquid, the device including: a hopper for storing a part or all parts of an anti-tack agent for unvulcanized rubber; a stirring tank for mixing the anti-tack agent for unvulcanized rubber mentioned above and water; and a quantitative feeder for supplying a constant amount of the aforementioned anti-tack agent in the aforementioned hopper to the stirring tank.

(7) An anti-tack agent for unvulcanized rubber stored in a container having the anti-tack agent for unvulcanized rubber as recited in any one of (1) to (6) mentioned above, and a container containing the anti-tack agent for unvulcanized rubber.

(8) The anti-tack agent for unvulcanized rubber stored in a container according to (7), wherein the container is a hopper-type container which has an opening part at an upper part, a discharge port at a bottom part, and a body part at least a lower portion of which has a gradually reduced diameter toward the discharge port.

(9) A method for producing an anti-tack liquid using a device for producing an anti-tack liquid, the device including a hopper for storing a part or all parts of an anti-tack agent for unvulcanized rubber, a stirring tank for mixing the anti-tack agent for unvulcanized rubber and water, and a quantitative feeder for supplying a constant amount of the anti-tack agent in the hopper mentioned above to the stirring tank, wherein as the anti-tack agent for unvulcanized rubber mentioned above, the anti-tack agent for unvulcanized rubber as recited in any one of (1) to (6) is used.

(10) A device for producing an anti-tack liquid, which includes: a hopper provided with an opening/closing valve at a discharge port at a bottom part thereof, which stores a part or all parts of the anti-tack agent for unvulcanized rubber; a quantitative feeder provided with a controlling means for controlling the opening/closing valve mentioned above; and a stirring tank for mixing the anti-tack agent for unvulcanized rubber and water.

(11) A device for producing an anti-tack liquid, which includes: a hopper provided with a cone valve which stores a part or all parts of the anti-tack agent for unvulcanized rubber; a quantitative feeder provided with a lifting/lowering means for lifting or lowering the cone valve; and a stirring tank for mixing the anti-tack agent for unvulcanized rubber and water.

(12) The device for producing an anti-tack liquid according to (10) or (11), which further includes: a supply tank for storing a liquid containing a part of the anti-tack agent for unvulcanized rubber mentioned above; and a supply means for quantitatively supplying the liquid from the supply tank to the stirring tank, wherein the hopper mentioned above stores a part of the remaining part or all parts of the anti-tack agent for unvulcanized rubber.

(13) The device for producing an anti-tack liquid according to any one of (10) to (12), which further includes a dispersion assisting device and a circulation channel for taking out a part of the liquid in the stirring tank and supplying the liquid to the stirring tank again through the dispersion assisting device mentioned above.

### Advantageous Effects of the Invention

The anti-tack agent for unvulcanized rubber of the present invention exhibits superior properties of suppressing solidification while the anti-tack agent is in the form of a solid. For this reason, the anti-tack agent is hardly solidified, and therefore, the anti-tack agent can be quantitatively supplied to a stirring tank at the time of producing an anti-tack liquid. In addition, the anti-tack agent is in the form of a solid, and for this reason, transportation costs and storage costs can be reduced, as compared with the form of a liquid.

The anti-tack agent for unvulcanized rubber according to the present invention is suitable for a method for producing an anti-tack liquid using a device for producing an anti-tack liquid provided with a quantitative feeder for quantitatively supplying an anti-tack agent for unvulcanized rubber.

The anti-tack agent for unvulcanized rubber stored in the container of the present invention exhibits superior properties of suppressing solidification while the anti-tack agent for unvulcanized rubber stored in the container is in the form of a powder, and it is difficult for the anti-tack agent to solidify. For this reason, a superior fluidity at the time of discharging can be exhibited. In addition, the anti-tack agent is in the form of a solid, and for this reason, transportation costs and storage costs can be reduced, as compared with the form of a liquid.

The device for producing an anti-tack liquid of the present invention can quantitatively supply an anti-tack agent for unvulcanized rubber to a stirring tank.

### BRIEF DESCRIPTION OF DRAWINGS

FIG. 1 is a schematic configuration diagram schematically showing one mode of a production system of unvulcanized rubber which has been subjected to an anti-tack treatment.

FIG. 2 is a schematic configuration diagram schematically showing one mode of a device for producing an anti-tack liquid.

FIG. 3 is a schematic configuration diagram schematically showing another mode of a device for producing an anti-tack liquid.

FIG. 4 is a schematic configuration diagram schematically showing yet another mode of a device for producing an anti-tack liquid.

### DESCRIPTION OF EMBODIMENTS

In the present specification, a moisture content of an anti-tack agent for unvulcanized rubber is a weight loss before and after drying, measured by drying a sample for 20 minutes at a sample surface temperature of 120° C. by means of an infrared moisture meter. The moisture content of the composition which is a part of the anti-tack agent for unvulcanized rubber is also the same as described above.

In the present specification, the form of a pellet means a molded product in the form of a particulate produced by a method of extruding a kneaded material of a raw material to mold and cutting it.

In the present specification, a product in the form of particles which are not a molded product and pass through a sieve with an opening of 100 μm, in an amount of 60% by mass or more, is referred to as “the form of a powder”, and a product in the form of particles passing through a sieve with an opening of 100 μm, in an amount of less than 60% by mass, is referred to as “the form of a granule”.

In the present specification, an average particle size of the anti-tack agent for unvulcanized rubber in the form of a powder is a 50% diameter in a volume-based integrated fraction measured by means of a laser diffraction method. More particularly, the average particle size can be measured by the following method. A sample is prepared by dispersing 0.01 parts by mass of an anti-tack agent for unvulcanized rubber in 100 parts by mass of distilled water. The sample mentioned above is put into a device for measuring the laser diffraction/scattering type particle size distribution, and is subjected to irradiation with a laser to measure the particle size distribution. The diameter at which the cumulative volume frequency is 50% (volume) is defined as the average particle size.

In the present specification, the average particle size of the anti-tack agent for unvulcanized rubber in the form of a granule is a 50% diameter in a mass-based integrated fraction measured by means of a sieving method. More particularly, the average particle size is measured by the following method. The anti-tack agent for unvulcanized rubber is put in each sieve and the mass remaining on the mesh is measured. The diameter at which the cumulative mass frequency is 50% is defined as the average particle size.

The average particle size of the anti-tack agent for unvulcanized rubber in the form of a pellet is represented by a major axis and a minor axis measured by means of a scale method. More particularly, the average particle size is measured by the following method. The major axis and the minor axis of 20 randomly selected pellets are measured, and the average value is calculated.

In the present specification, a “water-soluble” “polymer” means a material in which 1.0 g or more thereof is dissolved in 100 g of water at 25° C., and which has a viscosity at 20° C. of an aqueous solution at a concentration of 4% by mass that is 4.0 mPa·s or more. The viscosity mentioned above is a value measured with a Brookfield viscometer.

### Anti-Tack Agent for Unvulcanized Rubber

The anti-tack agent for unvulcanized rubber of the present embodiment (hereinafter also referred to simply as an anti-tack agent) has a moisture content that is more than 3% by mass but is 35% by mass or less with respect to the total mass of the anti-tack agent. The moisture content mentioned above preferably ranges from 5% by mass to 30% by mass, and more preferably ranges from 7% by mass to 25% by mass.

When the moisture content is not more than the upper limit value of the range mentioned above, superior properties of suppressing the solidification and superior solubility of the anti-tack agent for unvulcanized rubber are exhibited. In order to reduce transportation costs and storage costs, it is advantageous that the moisture content be reduced. When the moisture content is not less than the lower limit value of the range mentioned above, dust is hardly generated and a superior handling ability can be exhibited.

The anti-tack agent of the present embodiment is in the form of a solid, but it is difficult to solidify and a superior fluidity is exhibited. For this reason, the anti-tack agent is suitable for a device or a method for supplying a constant amount by dropping and discharging from a container such as a hopper (hereinafter also referred to as a storage container). For example, the anti-tack agent of the present invention is suitable as an anti-tack agent for quantitative supply by means of a quantitative supply device described later.

The anti-tack agent of the present embodiment is preferably a composition containing: at least one of component (A) and component (E); and component (B).

### Component (A)

Component (A) is a smectite. As examples of smectites, mention may be made of smectites such as montmorillonite, beidellite, nontronite, saponite, hectorite, saconite, and stevensite, and bentonite containing montmorillonite, and the like. One type of smectite may be used or two or more types of smectites in combination may be used.

Component (A) contributes to anti-tack properties by forming a coating film on the surface of the unvulcanized rubber.

An inorganic compound containing a smectite may be blended into the anti-tack agent. In this case, the smectite content in the inorganic compound mentioned above can be measured by the following measuring method.

### Method for Measuring Smectite Content

An inorganic compound containing a smectite is analyzed by X-ray diffraction, and a smectite content is calculated from a diffraction peak intensity derived from the smectite appeared in the vicinity of 2θ=7°. The analysis conditions for X-ray diffraction at the time of quantifying the smectite content are as follows.

X-Ray Diffraction Analysis Conditions
Measurement device: X'Pert PRO MRD (manufactured by PANalytical Ltd.)
Target: Cu
Tube voltage: 45 kV
Tube current: 40 mA
Scan axis: gonio
Scan range: 5° to 60°
Step size: 0.03°
Step time: 12.7 seconds
Divergence slit: ½°
Scattering slit: 1°
Light-receiving slit: None

A content of component (A) preferably ranges from 15% by mass to 80% by mass, more preferably ranges from 20% by mass to 75% by mass, and still more preferably ranges from 25% by mass to 70% by mass with respect to the total mass of the anti-tack agent. When the content of component (A) is at least the lower limit value of the range mentioned above, superior anti-tack properties can be exhibited. In addition, when the content of component (A) is at most the upper limit value, superior solubility of the anti-tack agent can be exhibited.

In the present specification, the content of component (A) corresponds to a dry mass.

### Component (B)

Component (B) is at least one material selected from the group consisting of inorganic silicates other than smectites, metal oxides, metal hydroxides, calcium carbonate, red iron oxide, carbon black, graphite, and metallic soaps.

Component (B) mainly acts as a lubricant and contributes to anti-tack properties. Component (B) exhibits superior solubility as compared with component (A).

As examples of inorganic silicates other than smectites, mention may be made of silicates such as kaolins (also referred to as kaolin clays), aluminum silicates, calcium silicate, clays, talc, micas, sericite, nepheline syenite, and the like.

As examples of metal oxides, mention may be made of silica, alumina, magnesium oxide, antimony trioxide, titanium oxide, white carbon, iron oxide, and the like.

As examples of metal hydroxides, mention may be made of aluminum hydroxide, magnesium hydroxide, iron hydroxide, and the like.

As metallic soaps, a metal (metal other than an alkali metal) salt of a long-chain fatty acid is preferable. As examples thereof, mention may be made of calcium stearate, zinc stearate, and magnesium stearate.

A content of component (B) preferably ranges from 3 to 71.7% by mass, more preferably ranges from 5 to 65% by mass, and further preferably ranges from 10 to 60% by mass with respect to a total mass of the anti-tack agent. When the content of component (B) is at least the lower limit value of the range mentioned above, superior anti-tack properties are exhibited. In addition, when the content is at most the upper limit value, the balance with other components is good.

In the present specification, the content of component (B) corresponds to a dry mass.

A ratio of component (A) to the total of component (A) and component (B) (A/(A+B)) preferably ranges from 20 to 100% by mass, more preferably ranges from 25 to 90% by mass, still more preferably ranges from 30 to 80% by mass, in particular preferably ranges from 30 to 70% by mass, and most preferably ranges from 30 to 50% by mass. When the ratio is at least the lower limit value of the range mentioned above, superior anti-tack properties are exhibited. In addition, when the ratio is at most the upper limit value, superior solubility is exhibited.

### Component (C)

The anti-tack agent preferably contains component (C) which is at least one material selected from the group consisting of inorganic carbonates excluding calcium carbonate, inorganic sulfates, inorganic chlorides, and inorganic phosphates.

Component (C) contributes to the improvement in solubility of component (A). In addition, component (C) increases the viscosity of the anti-tack liquid and contributes to the improvement in the adhesion of the anti-tack liquid to the surface of unvulcanized rubber.

As examples of component (C), mention may be made of inorganic alkali metal carbonates, sulfates, chlorides or phosphates, and inorganic alkaline earth metal carbonates (excluding calcium carbonate), sulfates, chlorides or phosphates. As the alkali metal, lithium, sodium or potassium is preferable. As the alkaline earth metal, magnesium, calcium or barium is preferable. As specific examples thereof, mention may be made of lithium carbonate, sodium carbonate, potassium carbonate, magnesium carbonate, barium carbonate, lithium sulfate, sodium sulfate, potassium sulfate, magnesium sulfate, calcium sulfate, barium sulfate, lithium chloride, sodium chloride, potassium chloride, magnesium chloride, calcium chloride, barium chloride, lithium phosphate, sodium phosphate, potassium phosphate, calcium phosphate, barium phosphate, and the like.

In the case of using component (C), a content of component (C) preferably ranges from 0.1 to 10% by mass, more preferably ranges from 0.1 to 8% by mass, and still more preferably ranges from 0.1 to 7% by mass, with respect to a total mass of the anti-tack agent. When the content of component (C) is at least the lower limit value of the range mentioned above, a superior effect of improving the solubility is exhibited. In addition, when the content is at most the upper limit value, superior anti-tack properties are exhibited.

In the present specification, the content of component (C) corresponds to a dry mass.

### Component (D)

The anti-tack agent preferably contains component (D), which is a surfactant.

Component (D) contributes to the improvement in the wettability of the anti-tack agent and the dispersibility in water.

As examples of component (D), the following (1) to (5) may be mentioned. As component (D), one type thereof may be used, or two or more types thereof may also be used in combination.

(1) Carboxylic acid-type anionic surfactant such as a higher fatty acid salt, an alkyl ether carboxylic salt, a polyoxyalkylene ether carboxylic salt, an alkyl (or alkenyl) amido ether carboxylic salt, or an acylaminocarboxylic salt.

(2) Sulfuric ester-type anionic surfactant such as a higher alcohol sulfuric ester salt, a polyoxyalkylene higher alcohol sulfuric ester salt, an alkylphenyl ether sulfuric ester salt, a polyoxyalkylene alkylphenyl ether sulfuric ester salt, or a glycerol fatty acid ester monosulfuric ester salt.

(3) Sulfonic acid-type anionic surfactant such as an alkane sulfonic salt, an alpha-olefin sulfonic salt, a linear alkylbenzene sulfonic salt, an alpha-sulfofatty acid ester salt, or a dialkyl sulfosuccinic salt.

(4) Phosphoric ester-type anionic surfactant such as an alkyl phosphoric ester salt, a polyoxyalkylene alkyl phosphoric ester salt, a polyoxyalkylene alkylphenyl phosphoric ester salt, or a glycerol fatty acid ester monophosphoric ester salt.

(5) Polyoxyalkylene alkyl ether-type nonionic surfactant.

A counter ion of the anionic surfactant is not particularly limited, and an alkali metal such as sodium or potassium, and an alkanolamine such as monoethanolamine or diethanolamine are preferable. They may be used alone or in combination of two or more types.

As the anionic surfactant, an alpha-olefin sulfonic salt and a dialkyl sulfosuccinic salt are preferable since an anti-tack liquid exhibiting superior wettability with the surface of the unvulcanized rubber can be obtained. As the alpha-olefin sulfonic salt, an alpha-olefin sulfonic acid Na salt “Lipolane (registered trademark) LB-840” (manufactured by Lion Specialty Chemicals Co., Ltd.) is more preferable, and as the dialkyl sulfosuccinic salt, a dioctyl sulfosuccinic acid Na salt is more preferable.

The nonionic surfactant is not particularly limited. For example, a nonionic surfactant represented by formula (1) shown below can be used. Use of the nonionic surfactant of the following formula (1) and an anionic surfactant in combination is particularly preferable. The nonionic surfactant represented by the following formula (1) is speculated to exhibit actions of lowering the surface tension of the anti-tack liquid with respect to the surface of the unvulcanized rubber, together with the anionic surfactant, and in addition, effectively improving adhesion of the anti-tack agent to the surface of the non-vulcanized rubber of the anti-tack agent. However, this speculation does not limit the present invention at all.

RO-(AO)ₙ—H (1)

In formula (1) mentioned above, R represents an aliphatic hydrocarbon group having 8 to 18 carbon atoms. The aliphatic hydrocarbon group mentioned above may be linear or branched. In addition, the aliphatic hydrocarbon group may be either saturated or unsaturated. The number of carbon atoms of R preferably ranges from 12 to 16, more preferably ranges from 12 to 14, and particularly preferably ranges from 12 to 13, from the viewpoint of superior dispersibility of component (A).

AO represents an oxyalkylene group having 2 to 4 carbon atoms, and n represents an average number of the addition moles of AO.

n may range, for example, from 1 to 30, from 1 to 25, or from 1 to 20. Specifically, n is preferably 1 or more (that is, not 0) from the viewpoint of the preventing of the surface activity from deteriorating, resulting in a decrease of the dispersibility of the component (A). In addition, from the viewpoint of preventing deterioration of adhesion caused by excessively high hydrophilicity, n is preferably a number of 30 or less, more preferably a number of 25 or less, and still more preferably a number of 20 or less. It may be speculated that, when n is preferably in the range of from 1 to 30, more preferably in the range of from 1 to 25, and still more preferably in the range of from 1 to 20, the dispersibility of component (A) is further improved, and even when the surface of unvulcanized rubber is highly hydrophobic, adhesion may be improved by imparting sufficient viscoelasticity to the coating film. However, this speculation does not limit the present invention.

The oxyalkylene group having 2 to 4 carbon atoms is, for example, a polymerization unit formed by addition polymerization of alkylene oxide having 2 to 4 carbon atoms. As specific examples of the oxyalkylene group having 2 to 4 carbon atoms, mention may be made of an oxyethylene group (EO) formed by addition of ethylene oxide, an oxypropylene group (PO) formed by addition of propylene oxide, and an oxybutylene group (BO) formed by addition of butylene oxide. (AO)n preferably contains at least an oxyethylene group (EO) in the structure thereof. Only an oxyethylene group (EO) may be contained, or an oxyethylene group (EO) and another oxyalkylene group may be contained therein. When (AO)n contains a plurality of types of oxyethylene groups (EO), oxypropylene groups (PO), and oxybutylene groups (BO), these groups may be arranged in a block form or may be arranged at random. (AO)n is preferably composed of only an oxyethylene group (EO), for example, from the viewpoint of a superior balance between hydrophilicity and hydrophobicity.

In the case of using component (D), a content of the component (D) preferably ranges from 1 to 20% by mass, more preferably ranges from 1 to 18% by mass, and still more preferably ranges from 1 to 15% by mass, with respect to a total mass of the anti-tack agent. When the content is at least the lower limit value of the range mentioned above, a superior effect of the improvement in the wettability of the anti-tack liquid with respect to rubber is exhibited. If the wettability is insufficient, repelling occurs. When the content is at most the upper limit value of the range mentioned above, a problem in which a large amount of foam is generated and an overflow occurs in a facility during use hardly occurs. In the present specification, the content of component (D) corresponds to a dry mass.

### Component (E)

Component (E) is a water-soluble polymer exhibiting a coating film-forming ability, acts as an anti-tack base and thereby contributes to anti-tack properties.

In the present invention, the water-soluble polymer “exhibiting a property of forming a coating film” means a water-soluble polymer determined to be “exhibiting an ability of forming a coating film” in the following film formation test. In the test, an aqueous solution (4% by mass aqueous solution) having a water-soluble polymer concentration of 4% by mass is used.

### Coating-Film Formation Test

In the case where a dried product obtained by placing 5 g of a 4% by mass aqueous solution in an aluminum dish having an inner diameter of 5 cm and drying at an atmospheric temperature of 105° C. for 2 hours forms a coating film without cracks, or a coating film with cracks but maintaining a state of a coating film, such a case is determined to be “exhibiting an ability of forming a coating film”.

As examples of component (E), mention may be made of a synthetic water-soluble polymer such as polyvinyl alcohol, polyvinyl pyrrolidone, water-soluble urethane resin, water-soluble melamine resin, water-soluble epoxy resin, water-soluble butadiene resin, or water-soluble phenol resin; a naturally occurring water-soluble polymer such as xanthan gum, guar gum, welan gum, locust bean gum, diutan gum, tamarind gum, tamarind seed gum, tragacanth gum, gum arabic, carrageenan, rhamsan gum, succinoglycan, tara gum, gellan gum, caraya gum, pectin, alginic acid derivatives, or cellulose ethers; hydroxyalkyl methylcellulose, and the like. As examples of hydroxyalkyl methylcellulose, mention may be made of hydroxyethyl methylcellulose, hydroxypropyl methylcellulose, hydroxybutyl methylcellulose, and the like, although examples are not particularly limited thereto.

Component (E) may be used as only one type, or as two or more types in combination.

Component (E) can be dispersed or dissolved in water by supplying it in the form of a solid to a stirring tank when an anti-tack liquid is produced.

In the case of using component (E), the content of the component (E) preferably ranges from 1 to 40% by mass, more preferably ranges from 2 to 35% by mass, and still more preferably ranges from 3 to 30% by mass with respect to the total mass of the anti-tack agent. When the content is at least the lower limit value of the range mentioned above, superior anti-tack properties can be exhibited. On the other hand, when the content is at most the upper limit value, superior solubility of the anti-tack agent can be exhibited.

In the present specification, the content of a component (E) corresponds to a dry mass.

In the case of using component (E) without using component (A), the ratio of component (E) to the total of component (E) and component (B) (E/(B+E)) preferably ranges from 2 to 100% by mass, more preferably ranges from 3 to 90% by mass, still more preferably ranges from 3 to 80% by mass, and in particular, preferably ranges from 3 to 70% by mass. When the ratio is at least the lower limit value of the range mentioned above, superior anti-tack properties can be exhibited. On the other hand, when the ratio is at most the upper limit value, superior solubility can be exhibited.

When component (A) and component (E) are used in combination, the ratio of the total of component (A) and component (E) to the total of component (A), component (E) and component (B) ((A+E)/(A+B+E)) preferably ranges from 2 to 100% by mass, more preferably ranges from 3 to 90% by mass, still more preferably ranges from 3 to 80% by mass, and in particular, preferably ranges from 3 to 70% by mass. When it is at least the lower limit value of the range mentioned above, superior anti-tack properties can be exhibited, and on the other hand, when the ratio is at most the upper limit value, superior solubility can be exhibited.

### Optional Components

The anti-tack agent may or may not contain an optional component other than the components (A) to (E). As examples of the optional component, mention may be made of an antifoaming agent, a wettable adjuvant, a viscosity adjuvant, and a contamination reducing adjuvant.

The total content of the optional components which do not correspond to the components (A) to (E) and water is preferably 10% by mass or less, more preferably 8% by mass or less, and still more preferably 7% by mass, with respect to the total mass of the anti-tack agent. The total content of the optional components may be zero.

In the present specification, the content of the optional component corresponds to a dry mass.

The antifoaming agent is not particularly limited. As examples of the antifoaming agent, mention may be made of a fat- and oil-based antifoaming agent such as castor oil, sesame oil, linseed oil, or an animal or vegetable oil; a fatty acid ester-based antifoaming agent such as isoamyl stearate, distearyl succinate, ethylene glycol distearate, or butyl stearate; an alcohol-based antifoaming agent such as a polyoxyalkylene monohydric alcohol di-t-amylphenoxyethanol, 3-heptanol, or 2-ethylhexanol; an ether-based antifoaming agent such as di-t-amylphenoxyethanol, 3-heptyl cellosolve, nonyl cellosolve, or 3-heptyl carbitol; a phosphoric ester-based antifoaming agent such as tributyl phosphate or tris(butoxyethyl) phosphate; an amine-based antifoaming agent such as diamylamine; an amide-based antifoaming agent such as a polyalkylene amide or acylate polyamine; a mineral oil; a silicone oil; and the like. The antifoaming agent may be used alone or two or more types thereof may be used in combination.

The wettable adjuvant is not particularly limited. For example, alcohols are exemplified. More specifically, as examples of the wettable adjuvant, mention may be made of methanol, ethanol, hexanol, glycerin, 1,3-butanediol, propylene glycol, dipropylene glycol, pentylene glycol, hexylene glycol, sorbitol, maltitol, sucrose, erythritol, xylitol, polyethylene glycol, polypropylene glycol, and adducts of ethylene oxide or propylene oxide of polyhydric alcohols. The wettable adjuvant may be used alone or two or more thereof may be used in combination.

The viscosity adjuvant is not particularly limited. For example, water-soluble polymers other than the component (E) may be exemplified. More specifically, as examples of the viscosity adjuvant, mention may be made of, for example, proteins, polyacrylic acid, sodium polyacrylate, polyacrylamide, polyethylene glycol, and polyethylene oxide. The viscosity adjuvant mentioned above may be used alone or two or more thereof may be used in combination.

### Form of Anti-Tack Agent and Production Method Thereof

The anti-tack agent of the present embodiment is preferably in the form of powder, granules or pellets.

The average particle size of the anti-tack agent preferably ranges from 0.03 to 30 mm, more preferably ranges from 0.03 to 25 mm, and still more preferably ranges from 0.03 to 20 mm. When the average particle size is at least the lower limit value of the range mentioned above, it is difficult for the anti-tack agent to scatter. On the other hand, when the average particle size is at most the upper limit value, it is difficult for the anti-tack agent to solidify. From the viewpoint of solubility, it is preferable that the average particle size be large and therefore the surface area be small, since formation of lumps at the time of dissolving the anti-tack agent can be suppressed and the dissolution time can be easily shortened.

The anti-tack agent in the form of powder can be produced by mixing all the components of the anti-tack agent, and water added as necessary. As examples of the device used for mixing, mention may be made of a powder mixer which performs stirring or oscillation stirring such as a ribbon mixer and a vertical screw mixer.

The average particle size of the anti-tack agent in the form of powder preferably ranges from 0.03 to 0.2 mm, and more preferably ranges from 0.03 to 0.1 mm.

The anti-tack agent in the form of granules can be produced by mixing all the components of the anti-tack agent and water added as necessary, and granulating the mixture. As examples of the granulation method, mention may be made of a high-speed stirring granulation method and a drum granulation method. As examples of the device used for mixing and granulation, mention may be made of a high-speed mixer, a ProShear mixer, a planetary mixer, and the like.

The average particle size of the anti-tack agent in the form of granules preferably ranges from 0.1 to 8 mm, more preferably ranges from 0.2 to 7 mm, and still more preferably ranges from 0.2 to 5 mm.

The anti-tack agent in the form of pellets can be produced by extrusion-molding a kneaded product obtained by kneading all components of the anti-tack agent and water added as necessary, and cutting the same. A common pelletizer can be used as the device. For example, a disk pelletizer (product name: Disk Pelleter F-15, manufactured by Dalton Corporation) may be mentioned.

The size of the anti-tack agent in the form of pellets preferably ranges from 2 to 8 mm in minor axis and ranges from 2 to 30 mm in major axis, more preferably ranges from 2 to 7 mm in minor axis and ranges from 3 to 25 mm in major axis, and still more preferably ranges from 2 to 7 mm in minor axis and ranges from 3 to 20 mm in major axis.

The anti-tack agent may be obtained by dividing all components into two or more types of compositions. That is, the anti-tack agent composed of two or more types of compositions may be used. The component contained in each composition may be only one of all components or a mixture of two or more thereof. Each composition is preferably in the form of powder, granules, or pellets.

When the anti-tack agent comprising two or more compositions is dissolved in water to produce an anti-tack liquid, all parts of the compositions may be supplied as an independent solid (powder, granule, or pellet). Alternatively, a part of the compositions may be supplied in a state of being previously dissolved or dispersed in water, and the remaining parts of the compositions may be supplied as a solid. At least one type of composition is provided as a solid.

The anti-tack agent comprising two or more types of compositions has a total moisture content, that is, a moisture content in a state where all the components are mixed so as to be the target anti-tack agent for unvulcanized rubber, that is more than 3% by mass but is 35% by mass or less, preferably ranges from 5 to 30% by mass, and more preferably ranges from 7 to 25% by mass.

The moisture content in each composition alone is preferably more than 3% by mass but is 35% by mass or less, more preferably ranges from 5 to 30% by mass, and still more preferably ranges from 7 to 25% by mass in the case of the composition supplied as a solid when an anti-tack liquid is produced.

In addition, the respective moisture content of all the compositions is preferably more than 3% by mass but is 35% by mass or less, more preferably ranges from 5 to 30% by mass, and still more preferably ranges from 7 to 25% by mass.

As specific examples of the anti-tack agent comprising two or more compositions, mention may be made of the following ones.

(1) An anti-tack agent comprising a first composition containing component (A) or component (E) and a second composition containing component (B). In the production of the anti-tack liquid, the first composition is supplied as a solid, and the second composition is supplied as a liquid in which the component is previously dissolved or dispersed in water. Thereby, the dissolution time for producing the anti-tack agent can be further shortened.

(2) An anti-tack agent containing a first composition containing component (A) and a second composition containing component (B) and component (E). In the production of the anti-tack liquid, the first composition is supplied as a solid, and the second composition is supplied as a liquid in which the components are previously dissolved or dispersed in water. Thereby, the dissolution time for producing the anti-tack agent can be further shortened.

The anti-tack agent of this embodiment preferably has an appropriate fluidity. An angle of repose (unit: “°”) obtained by the following measurement method is an indicator of the fluidity of the solid anti-tack agent. As the angle of repose is reduced, the fluidity is increased.

More specifically, the angle of repose of the anti-tack agent in the form of granules preferably ranges from 70° to 90°. The angle of repose of the anti-tack agent in the form of powder preferably ranges from 70° to 90°. The angle of repose of the anti-tack agent in the form of pellets preferably ranges from 70° to 90°. The angle of repose in this specification is a value measured under an atmosphere at a temperature of 25° C. with a relative humidity of 60%.

When the angle of repose of the anti-tack agent is at most the upper limit value of the range mentioned above, the anti-tack agent is easily discharged from a container or a hopper, and superior workability can be exhibited. On the other hand, when it is at least the lower limit value, a discharge speed is not too high in the case of the anti-tack agent being quantitatively dropped (discharged) from the bottom of the hopper or the like, and superior quantitative properties can be exhibited.

The angle of repose of the anti-tack agent of this embodiment can be adjusted, for example, with the blending amount of a liquid raw material. Specifically, the angle of repose tends to increase when the amount of the liquid raw material is increased. On the other hand, the angle of repose tends to decrease when the amount of the liquid raw material is decreased.

As examples of the liquid raw material, mention may be made of water (moisture), a liquid surfactant, an aqueous solution of a surfactant, and the like.

The blending amount of the liquid raw material is preferably more than 4% by mass but 50% by mass or less, more preferably ranges from 5 to 45% by mass, and still more preferably ranges from 6 to 40% by mass with respect to the total mass of the anti-tack agent.

### Measurement Method of Angle of Repose

The angle of repose is measured as follows. As a measurement device, a rectangular parallelepiped container having an opening part at an upper part and a side lid on the side surface on the short side is used. As the dimension of the inner surface of the container, a height is 10 cm, a width (short side length) is 3 cm, and a length (long side length) is 10 cm. When this rectangular parallelepiped container is placed horizontally and the side lid is closed, about 280 cm3 of an anti-tack agent is gently added from the opening part at the upper part of the container. Next, when the side lid is gently opened, a part of the anti-tack agent flows out from the container. When the flow of the anti-tack agent stops, the angle between the slope formed by the anti-tack agent remaining in the container and the bottom of the container is measured. The angle is defined as the angle of repose.

### Usage Method

The anti-tack agent is used as an anti-tack liquid obtained by dissolving in water.

Specifically, water and an anti-tack agent are mixed at a predetermined ratio to produce an anti-tack liquid.

The content of the anti-tack agent with respect to the total mass of the anti-tack liquid is not particularly limited, but preferably ranges from 1 to 7% by mass, preferably ranges from 1.5 to 5% by mass, and more preferably ranges from 2 to 4% by mass.

When the anti-tack agent contains component (A) and component (B), the total content of the component (A) and the component (B) with respect to the total mass of the anti-tack liquid is not particularly limited, but for example, preferably ranges from 65 to 95% by mass, preferably ranges from 70 to 92% by mass, and more preferably ranges from 72 to 90% by mass.

When the anti-tack agent contains component (E) and component (B), the total content of the component (E) and the component (B) with respect to the total mass of the anti-tack liquid is not particularly limited, but for example, preferably ranges from 65 to 95% by mass, preferably ranges from 70 to 92% by mass, and more preferably ranges from 75 to 90% by mass.

When an anti-tack agent contains component (A), component (E), and component (B), the content of the total of the component (A), the component (E), and the component (B) with respect to the total mass of an anti-tack liquid is not particularly limited, but for example, preferably ranges from 65 to 95% by mass, preferably ranges from 70 to 92% by mass, and more preferably ranges from 75 to 90% by mass.

The anti-tack liquid is used for an anti-tack treatment of unvulcanized rubber. That is, the anti-tack agent is used in a method for producing an unvulcanized rubber that has been subjected to an anti-tack treatment.

The method for producing an unvulcanized rubber which has been subjected to an anti-tack treatment using an anti-tack agent has a step of carrying out an anti-tack treatment by adhering an anti-tack liquid to the surface of the unvulcanized rubber, and evaporating the solvent to apply the anti-tack agent to the surface of the unvulcanized rubber.

Even if such an unvulcanized rubber which has been subjected to the anti-tack treatment, as manufactured in this way, is stored after being stacked or folded, it is possible to prevent the unvulcanized rubber from coming into close contact with each other so that they cannot be separated.

The type of rubber to which the anti-tack agent for the unvulcanized rubber can be applied is not particularly limited as long as it is an unvulcanized rubber. As examples of the rubber type, mention may be made of rubber such as natural rubber (NR), butadiene rubber (BR), styrene butadiene rubber (SBR), IIR (butyl rubber), or EPDM (ethylene propylene rubber), and rubber in which several types thereof are mixed.

### Anti-Tack Agent for Unvulcanized Rubber Contained in a Container

The anti-tack agent for unvulcanized rubber contained in a container according to the present embodiment has the anti-tack agent for unvulcanized rubber according to the present embodiment and a container containing the same.

The container is not particularly limited as long as the container can store the anti-tack agent and is transportable. For example, a hopper-type container having a shape which can be used as a hopper, a flexible container, and the like may be mentioned. The hopper-type container has, for example, an opening part at the upper part, and a discharge port at the bottom part, and is in a shape in which at least the lower part of the body part is gradually reduced in diameter toward the discharge port. The discharge port of the hopper-type container can be opened and closed, and includes a mechanism for closing the discharge port during transportation and opening the discharge port at the time of discharging the anti-tack agent.

The material of the container is preferably insoluble in water. For example, various types of stainless steels, high-density polyethylene and the like may be exemplified.

### Production System of Unvulcanized Rubber Subjected to Anti-Tack Treatment

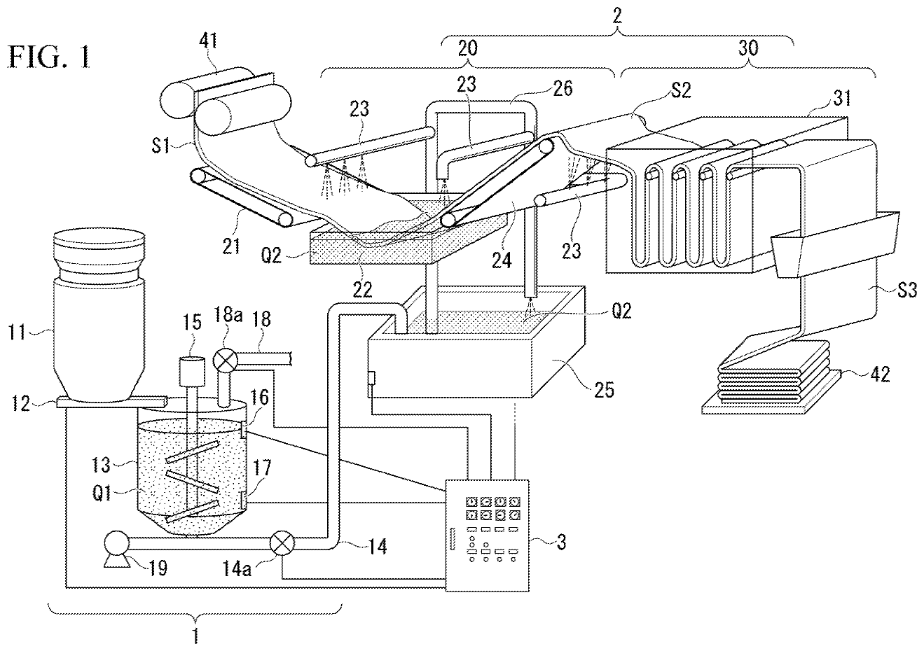

FIG. 1 is a schematic configuration diagram schematically showing a first embodiment of a production system suitable for the production of unvulcanized rubber which has been subjected to an anti-tack treatment.

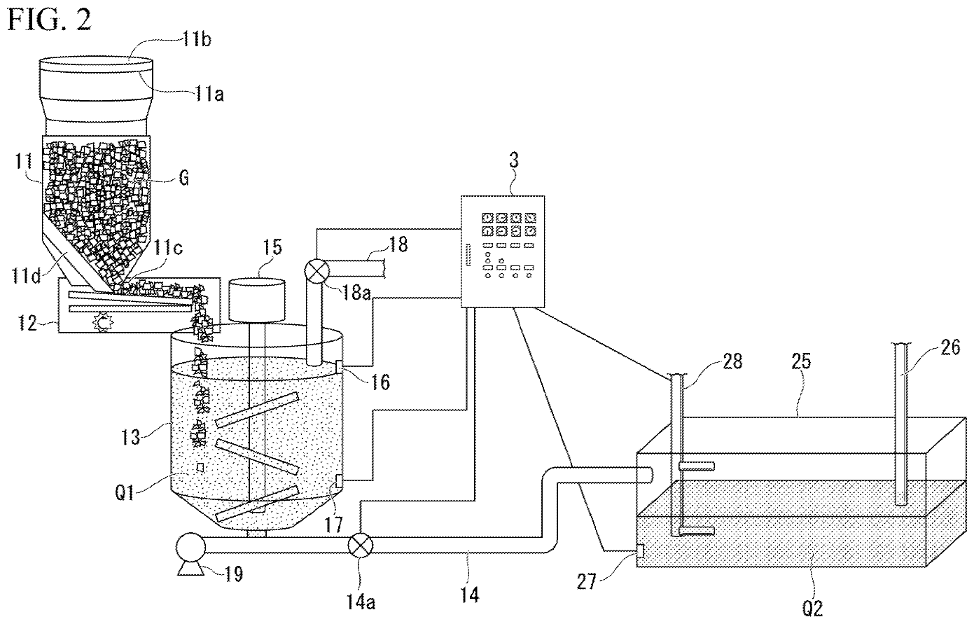

The production system of this embodiment is provided with a device for producing an anti-tack liquid 1, an anti-tack treatment device 2, and a control device 3. FIG. 2 is a schematic configuration diagram of the anti-tack liquid production device 1.

The anti-tack liquid production device 1 is provided with a hopper 11 for containing an anti-tack agent G, a stirring tank 13 for mixing the anti-tack agent G and water, a quantitative feeder 12 for supplying the anti-tack agent G from the hopper 11 to the stirring tank 13, and a pipe 14 for supplying an anti-tack liquid Q1 in the stirring tank 13 to the anti-tack treatment device 2.

The anti-tack treatment device 2 has an anti-tack liquid adhesion part 20 for adhering the anti-tack liquid Q2 to an unvulcanized rubber sheet S1 extruded from a rubber extruder 41, and a drying part 30 for cooling and drying an unvulcanized rubber sheet S2 to which the anti-tack liquid Q2 is attached.

The anti-tack liquid adhesion part 20 includes an immersion tank 22 in which the anti-tack liquid Q2 is stored, a conveyor 21 for transferring the unvulcanized rubber sheet S1 to the immersion tank 22, a conveyor 24 for transferring the unvulcanized rubber sheet S2 which has passed through the immersion tank 22 to the drying unit 30, a spraying device 23 for spraying the anti-tack liquid Q2 to the unvulcanized rubber sheet S1 or S2 being transferred, a stock tank 25 for storing the anti-tack liquid Q2, and a pipe 26 for supplying the anti-tack liquid Q2 from the stock tank 25 to the immersion tank 22 and the spraying device 23, and circulating the excess anti-tack liquid Q2 from the immersion tank 22 and the spraying device 23 to the stock tank 25. Reference numeral 42 denotes a storage part for the unvulcanized rubber sheet S3 which has been subjected to the anti-tack treatment.

In the anti-tack liquid production device 1 of this embodiment, steps of preparing an anti-tack liquid Q1 by mixing water and an anti-tack agent G in a predetermined ratio and supplying the anti-tack liquid Q1 to the anti-tack treatment device 2 are carried out.

In this embodiment, the hopper 11 stores a solid anti-tack agent G. The anti-tack agent G is preferably in the form of powder, granules, or pellets. When the capacity of the hopper 11 is large, the number of times of supplying the anti-tack agent G to the hopper 11 can be reduced. For example, the hopper has a size that can store an anti-tack agent in an amount of about 1 t.

The hopper 11 is formed from a material which has durability against the capacity which has been set. Plastics and metals used as general hopper materials can be used. As the molding method, a blow molding method or a press molding method can be used in the case of plastic, and a welding method can be used in the case of metal.

The hopper 11 has an opening part 11a at an upper part. For example, the anti-tack agent G which has been filled in a flexible container or the like and transported is supplied from the opening part 11a into the hopper 11. A lid 11b which can partially open and close the opening part 11a of the hopper 11 may be provided in order to suppress scattering of the anti-tack agent G when the anti-tack agent G is introduced into the hopper 11.

The quantitative feeder 12 is provided at the lower part of the hopper 11, and supplies a predetermined amount of the anti-tack agent G which is dropped and discharged from a discharge port 11c of the hopper 11 to the stirring tank 13. Reference numeral 11d is a guide, and makes the anti-tack agent G flow easily. As the quantitative feeder 12, a known quantitative feeder can be used. A screw feeder or a rotary feeder is suitable in view of easily increasing the supplying amount. In these feeders, the supplying amount of the anti-tack agent can be controlled by controlling the rotation speed.

A shutter valve (not shown in the drawings) may be provided at the discharge port 11c of the hopper 11. By providing the shutter valve, contamination of water vapor from the stirring tank 13 into the hopper 11 can be suppressed, and solidification of the anti-tack agent G in the hopper 11 can be prevented.

The stirring tank 13 is made of metal and is provided with a stirring device 15. The capacity of the stirring tank 13 is, for example, about 1,000 to 1,500 L. The stirring tank 13 is supplied with the quantified anti-tack agent G from the quantitative feeder 12 to the stirring tank 13, and at the same time, supplied with water from a water supplying pipe 18. The stirring tank 13 is provided with a float sensor 16 for detecting the water surface. The quantitative feeder 12, the float sensor 16, and an electromagnetic valve 18a of the water supplying pipe 18 are controlled by the control device 3. By controlling the amount of the anti-tack agent G and the amount of water supplied to the stirring tank 13 by means of the control device 3, the concentration of the anti-tack liquid Q1 in the stirring tank 13 is controlled.

The stirring tank 13 is provided with a conductivity sensor 17 so that the concentration of the anti-tack liquid Q1 in the stirring tank 13 can be monitored. The electrical conductivity changes depending on the composition of the anti-tack agent G, the liquid temperature of the anti-tack liquid Q1, and the hardness of water. For this reason, the control device 3 is therefore provided with a programming computer in which data of each condition is previously input into a database.

The anti-tack liquid Q1 produced in the stirring tank 13 is supplied to a stock tank 25 through the pipe 14. Reference numeral 19 denotes a pump. In addition, water is supplied to the stock tank 25 from a water supply pipe (not shown in the drawings). The stock tank 25 is provided with a concentration sensor 27 for monitoring the concentration of the anti-tack liquid Q2 in the stock tank 25. As the concentration sensor 27, a conductivity sensor or a sensor utilizing a marker can be used.

The stock tank 25 is provided with a level gauge 28 for monitoring the amount of the anti-tack liquid Q2 in the stock tank 25.

The concentration sensor 27, the level gauge 28, and the electromagnetic valve (not shown) of the water supply pipe, and the electromagnetic valve 14a of the pipe 14, in the stock tank 25 are controlled by the control device 3. The control device 3 controls the electromagnetic valve 14a of the pipe 14 and the electromagnetic valve of the water supply pipe so that the concentration detected by the concentration sensor 27 can be within a predetermined concentration range set in advance and the amount of liquid in the stock tank 25 can be maintained within the predetermined range.

In an example of the control method in the control device 3, the method has a step of measuring the concentration of the anti-tack liquid Q2 in the stock tank 25 by the concentration sensor 27 and transmitting it to the control device 3, a step of previously comparing with a predetermined value which has been set in advance in the control device 3 and determining whether to supply the water or the anti-tack liquid from the anti-tack liquid production device 1 to the stock tank 25 based on the comparison result, and a step of instructing the electromagnetic valve 14a of the pipe 14 and the electromagnetic valve of the water supplying pipe to open, close or maintain.

When such a control method is used, it is possible to reliably manage the concentration of the anti-tack agent in the anti-tack liquid Q2 used in the anti-tack treatment device 2. If the concentration of the anti-tack agent in the anti-tack liquid Q2 is significantly reduced, adhesion of the unvulcanized rubber sheet S3 treated with the anti-tack agent is likely to occur during storage. On the other hand, if the concentration of the anti-tack agent in the anti-tack liquid Q2 is significantly increased, the unvulcanized rubber sheet S3 treated with the anti-tack agent tends to be in an undried state. These problems can be prevented by managing the concentration of the anti-tack agent in the anti-tack liquid Q2 and maintaining it at a predetermined concentration. In addition, the amount of the anti-tack agent adhering to the unvulcanized rubber, that is, the amount of the anti-tack agent kneaded into the final rubber product can be controlled, and this can lead to the improvement in quality of the final product.

In addition, in this embodiment, the information obtained by the control device 3 can be transmitted externally through the internet. For example, the data on the amount of the anti-tack agent used and the operation status of the equipment are transmitted to information equipment of a purchasing department and a technical department of a rubber manufacturer that is the supplier of the unvulcanized rubber. Thereby, the efficiency of management work in the production of unvulcanized rubber which has been subjected to an anti-tack treatment can be performed.

In the anti-tack treatment device 2, an anti-tack liquid adhesion step of adhering the anti-tack liquid Q2 to the unvulcanized rubber sheet S1 and a drying step of drying the unvulcanized rubber sheet S2 to which the anti-tack liquid Q2 has been adhered, to obtain an unvulcanized rubber sheet S3 which has been subjected to an anti-tack treatment are carried out.

In the anti-tack liquid adhesion step, it is preferable that the anti-tack liquid Q2 be adhered to the unvulcanized rubber sheet S1 in a high-temperature state (for example, about 80 to 150° C.) by the heat at the time of molding into a sheet or the like.

As examples of a method of adhering the anti-tack liquid, mention may be made of a dipping method in which the unvulcanized rubber is immersed in the anti-tack liquid Q2 for a short period of time, a spraying method in which the anti-tack liquid Q2 is sprayed on the unvulcanized rubber with a shower device, and a coating method in which the anti-tack liquid Q2 is applied to the unvulcanized rubber. In this embodiment, the dipping method and the spraying method are used in combination.

The temperature of the anti-tack liquid Q2 in the immersion tank 22 and the stock tank 25 preferably ranges from 10 to 60° C., more preferably ranges from 20 to 55° C., and still more preferably ranges from 25 to 50° C.

In the drying step of this embodiment, the unvulcanized rubber sheet S2 to which the anti-tack liquid Q2 is adhered is introduced into a dryer 31 and is transferred thereto, to be dried while being allowed to cool. The temperature in the dryer 31 preferably ranges from 20 to 80° C., more preferably ranges from 30 to 75° C., and still more preferably ranges from 35 to 70° C.

The unvulcanized rubber sheet S3 which has been subjected to the anti-tack treatment, after drying, is transferred to a storage part 42.

According to the production system of the unvulcanized rubber subjected to the anti-tack treatment of this embodiment, the concentration management of the anti-tack liquid Q1 prepared by the anti-tack liquid production device 1 and the concentration management of the anti-tack liquid Q2 used in the anti-tack treatment device 2 can be automatically and quickly carried out using the control device 3. Therefore, it is possible to maintain the concentrations of the anti-tack liquids Q1 and Q2 appropriately, optimize the treatment amount of the anti-tack agent, and improve the quality of the processed rubber. In addition, the burden on the operator can be reduced, and the efficiency of factory management work can be improved.

In particular, when the anti-tack agent of the present embodiment is used as the anti-tack agent G, the anti-tack agent is hardly solidified. For this reason, the quantitative supply from the quantitative feeder 12 to the stirring tank 13 can be performed with higher accuracy.

In addition, when an anti-tack agent having better solubility is used, the dissolution period of time can be further shortened.

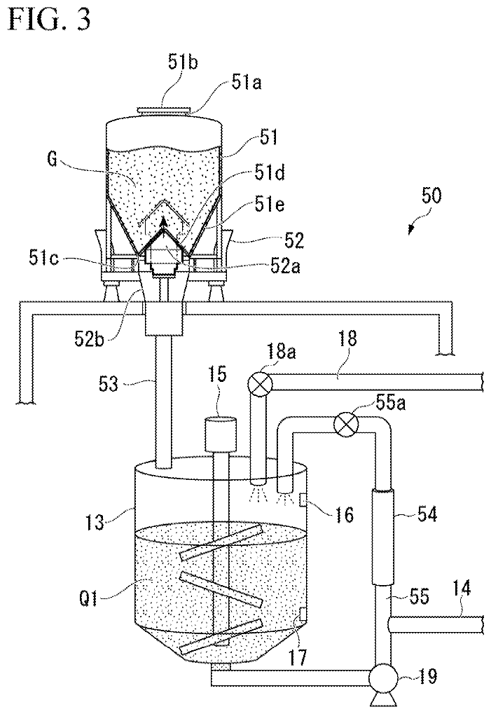

FIG. 3 is a schematic configuration diagram showing a second embodiment of the anti-tack liquid production device. The same components as those in FIG. 1 have the same numerical references as those therein and description thereof is omitted.

The hopper in the anti-tack liquid production device 50 according to the present embodiment is a transportable hopper type container, and is hereinafter referred to as a hopper container 51. The hopper container 51 is used by being mounted on a discharge device (quantitative feeder) 52.

The hopper container 51 has an opening part 51a at the upper part and a discharge port 51c at the bottom part. The opening part 51a is closed by a lid 51b, and the discharge port 51c is closed by a cone valve (open/close valve) 51d. A lower part 51e of the body part of the hopper container 51 is gradually reduced in diameter toward the discharge port 51c.

The discharge device 52 is provided with a discharge hopper 52b, and can hold the hopper container 51 in a state of being connected to the discharge hopper 52b. On the inside of the discharge hopper 52b, an open/close valve control means is provided. Specifically, a probe 52a and an air actuator (not shown in the drawings) are provided as a lifting/lowering means for lifting and lowering the cone valve 51d.

When the hopper container 51 containing the anti-tack agent G is attached to the discharge device 52, the discharge port 51c of the hopper container 51 and the discharge hopper 52b are connected in an airtight manner. In addition, the cone valve 51d and the probe 52a are tightly connected to each other and integrated. When the probe 52a and the cone valve 51d are moved up and down integrally, the anti-tack agent G drops to the discharge hopper 52b through the gap between the discharge port 51c of the hopper container 51 and the cone valve 51d. The size of the gap mentioned above is controlled by the raised amount of the cone valve 51d, and the amount of the anti-tack agent G dropped is controlled.

In addition, the cone valve 51d can be vibrated by the vibration function of the probe 52a, and thereby the anti-tack agent G in the hopper container 51 can be vibrated. Thereby, the fluidity of the anti-tack agent G in the hopper container 51 is further improved, and the quantitative property is further improved.

The anti-tack agent G dropped and discharged from the hopper container 51 is supplied to the stirring tank 13 through the supply pipe 53 connected to the discharge hopper 52b.

When the hopper container 51 becomes empty, the hopper container 51 is removed from the discharge device 52 and replaced with the hopper container 51 containing the anti-tack agent G.

According to this embodiment, the same effect as that in the first embodiment can be obtained.

In particular, this embodiment is suitable for accurately supplying a fixed amount of the anti-tack agent G from the hopper container 51 to the stirring tank 13, and can accurately manage the concentration of the anti-tack liquid.

In addition, the discharge port 51c of the hopper container 51 and the discharge hopper 52b are air tightly connected. For this reason, dust generation during discharging the anti-tack agent G can be prevented.

Furthermore, the anti-tack agent G can be carried in the state that the anti-tack agent G is stored in the hopper container 51, and for this reason, the dust generation at the time of supplying the anti-tack agent G can be prevented.

In addition, the anti-tack liquid production device 50 according to this embodiment includes a circulation channel 55 provided with a static mixer 54 as a dispersion-assisting device, in addition to the stirring tank 13 provided with the stirring device 15. The static mixer 54 is a static mixer for mixing and dispersing the fluid by generating an action such as division, conversion, inversion, or the like by means of an element provided in the pipe.

In this embodiment, by operating an electromagnetic valve 55a of the circulation channel 55 by means of the control device 3, a part of the anti-tack liquid Q1 produced in the stirring tank 13 is introduced into the circulation channel 55 and mixed by the static mixer 54, and subsequently, the anti-tack liquid Q1 can be made to flow again into the stirring tank 13. The remaining anti-tack liquid Q1 is supplied to the stock tank 25 via the pipe 14.

In addition, as the dispersion-assisting device, instead of the static mixer, a mixer provided with a Venturi tube or a mixer provided with a rotary mixer such as a homodisper or a homomixer may be provided on the circulation channel 55. The mixers mentioned above may be combined. In the Venturi tube, mixing and dispersing can be carried out by means of a specific flowing cavitation.

When such a dispersion-assisting device is provided, it is easy to suppress the formation of lumps when the powder is dissolved. For example, smectite or a water-soluble polymer tends to form lumps. By virtue of suppressing the formation of lumps, the dissolution period of time can be shortened and productivity can be improved.

In an embodiment other than this embodiment, the dispersion-assisting device mentioned above may be provided.

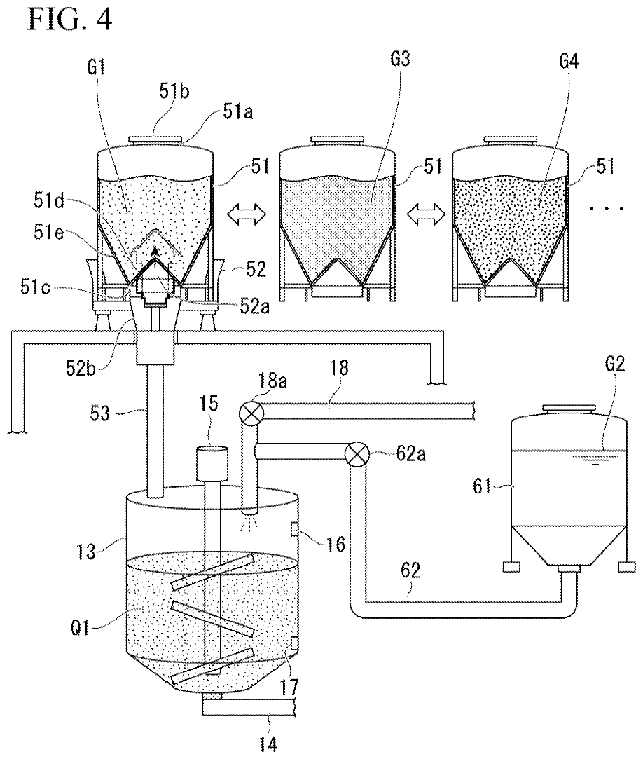

FIG. 4 is a schematic configuration diagram showing a third embodiment of the anti-tack liquid production device. The same components as those in FIG. 1 and FIG. 3 are denoted by the same reference numerals and description thereof is omitted.

An anti-tack liquid production device 60 of this embodiment is provided with a supply tank 61 for storing liquid components. In addition, a supply pipe 62 and an electromagnetic valve 62a are provided as feeding means for supplying a constant amount of the liquid in the supply tank 61 to the stirring tank 13.

The anti-tack liquid production device 60 of this embodiment is suitable for an embodiment in which an anti-tack liquid is produced using an anti-tack agent composed of two or more types of compositions. For example, all components of the anti-tack agent are divided into two compositions, which are referred to as a first composition G1 and a second composition G2. The first composition G1 is stored in the hopper container 51 in a powder state, and is quantitatively supplied to the stirring tank 13 by controlling the lifting and lowering operation of the cone valve 51d. The second composition G2 is stored in the supply tank 61 in a state of being dispersed in water in advance, and quantitatively supplied to the stirring tank 13 through a supply pipe 62. The feeding amount of the second composition G2 can be controlled by operating the electromagnetic valve 62a by means of the control device 3.

In an embodiment other than this embodiment, the supply tank 61, the supply pipe 62, and the electromagnetic valve 62a may be provided.

In addition, the anti-tack liquid production device 60 of this embodiment is suitable for the embodiment which changes the composition of the anti-tack agent in the anti-tack liquid as needed. For example, in addition to the hopper container 51 containing the first composition G1, hopper containers 51 respectively containing compositions G3 and G4 having the compositions different from the first composition G1 are prepared. By changing the hopper container 51 attached to the discharge device 52, the composition of the powder supplied to the stirring tank 13 can be changed to G1, G3, or G4.

Thereby, the concentration or the composition of the anti-tack liquid according to the type of rubber can be easily changed. If the configuration of automatically changing of the hopper container 51 is applied, it is possible to reduce the work that has conventionally relied on an operator, to suppress the use of unnecessary anti-tack agents, and to reduce the manufacturing costs.

### EXAMPLES

Hereinafter, the present invention is described in detail with reference to Examples. It should be understood that the present invention is not limited by the following description.

### Measurement Method/Evaluation Method

### Moisture Content of Anti-Tack Agent

An infrared moisture analyzer (manufactured by Kett Scientific Laboratory, FD-600-2) was used. An anti-tack agent was used as a sample and 5.0 g of the sample was weighed. The sample was placed on an aluminum dish and dried for 20 minutes at 120° C., and the weight loss before and after drying was measured as a moisture content.

### Suppression of Solidification

An anti-tack agent was placed in a cubic cell having a side of 1 cm, and was allowed to stand for 48 hours under the condition of exerting a load of 9.8×103 N/m2 (1 t/m2) in an atmosphere having a temperature of 25° C. and a relative humidity of 40%. The press-molded anti-tack agent (hereinafter also referred to as a molded product) was taken out of the cell, and placed on an electronic balance. A pressure arm was lowered thereon under the condition of 500 mm/second to gradually apply a load to the entire upper surface of the molded product. The maximum load (kg) exerted until the molded product was broken was measured.

A molded product having the reduced maximum load exhibits superior suppression of solidification. The case in which the maximum load is 2.0 kg or less is set as “passed”.

### Solubility

980 g of water was put into a beaker with a volume of 1 L, and 20 g of the anti-tack agent obtained in each of the Examples was added thereto while stirring the water with a stirring bar. The dissolution period of time until undissolved residue was not visually observed was measured. As the stirring bar, a stirring bar in which two propeller blades (diameter 4 cm) were provided at intervals of 3 cm was used.

Superior solubility is obtained as the dissolution period of time is shorter. The case in which the dissolution period of time is within 60 minutes is set as “passed”.

### Anti-Tack Property

20 g of an anti-tack agent (molded product) obtained by carrying out the pressure molding in the same manner as that described in the method for evaluating suppression of solidification mentioned above was dissolved in 980 g of water in the same manner as in the above-described solubility evaluation method. By using the anti-tack liquid obtained with a dissolution period of time of 60 minutes, a rubber sheet was subjected to an anti-tack treatment by the following method.

Unvulcanized rubber (unvulcanized NR/BR rubber) having the following composition was kneaded with an open roll at a temperature of 80° C. to form a rubber sheet (thickness: 5 mm, 60 cm×15 cm), and the rubber sheet immediately after being fed out was immersed in 1,000 g of an anti-tack liquid in which the temperature thereof was adjusted to 40° C., for about 1 second. Subsequently, the rubber sheet was quickly pulled up vertically, allowed to stand in a vertical state in an atmosphere of a temperature of 25° C. and a relative humidity of 40%, and air-dried for 10 minutes.

Thereafter, the rubber sheet was cut into a piece of 6 cm×15 cm, and two pieces were stacked to obtain a test piece in a laminated state. A load of 3.9×103 N/m2 (400 kg/m2) was exerted on the test piece in the vertical direction from one surface, and was allowed to stand in an atmosphere of a temperature is 60° C. and a relative humidity of 30%, for 12 hours.

Thereafter, the test piece was returned to an atmosphere of a temperature of 25° C. and a relative humidity of 40%, and a 180° peeling test was carried out using a tensile tester (product name: AGS-500D, manufactured by Shimadzu Corporation), and the peeling resistance (N/cm) was measured at the pulling speed of 300 mm/minute. As the peeling resistance is smaller, the anti-tack property becomes superior.

### Composition of Unvulcanized NR/BR Rubber

Unvulcanized NR/BR rubber in which with respect to 100 parts by mass of the total of 70 parts by mass of NR (RSS #3) and 30 parts by mass of BR (product name “BR-01” manufactured by JSR Corporation), 10 parts by mass of white carbon (product name “Nipsil VN-3” manufactured by Tosoh Silica Corporation), 30 parts by mass of ISAF Black (product name “SEAST 6”, manufactured by Tokai Carbon Co., Ltd.), 15 parts by mass of JSR AROMA (process oil) (product name “AROMA 790”, manufactured by Japan Sun Oil Co., Ltd.), 3 parts by mass of zinc white (manufactured by Hakusui Tech Co., Ltd., 2 types of zinc white), 1 part by mass of stearic acid (manufactured by NOF Corporation, tsubaki), 1 part by mass of 6 PPD (product name “NOCRAC 6C”, manufactured by Ouchi Shinko Chemical Industry Co., Ltd.), 1 part by mass of CBS (product name “NOCCELER CZ-G”, manufactured by Ouchi Shinko Chemical Industry Co., Ltd.), and 1.5 parts by mass of sulfur (manufactured by Tsurumi Chemical Industry Co., Ltd.) (Total: 162.5 parts by mass) were blended.

### Raw Materials Used

### Component (A)

A-1: Hectorite (manufactured by Hectlite 200, manufactured by American colloid company, moisture content: 5% by mass).

### Component (B)

B-1: Light calcium carbonate (light calcium carbonate, manufactured by Konoshima Chemical Co., Ltd., moisture content: 0% by mass).

B-2: Kaolin clay (MC hard clay (product name), manufactured by Seto Ceramic Raw Materials Co., Ltd., moisture content: 0% by mass).

B-3: Mica (Repco Mica M-60 (product name), manufactured by Repco Co., Ltd., moisture content: 0% by mass).

B-4: Calcium stearate (Ca-St, manufactured by Nitto Chemical Industry Co., Ltd., moisture content: 0% by mass).

### Component (C)

C-1: Sodium carbonate (purified sodium carbonate, manufactured by Daito Chemical Co., Ltd., moisture content: 0% by mass).

C-2: Magnesium carbonate (heavy magnesium carbonate, manufactured by Konoshima Chemical Co., Ltd., moisture content: 2.5% by mass).

### Component (D)

D-1: α-olefin sulfonic acid Na (LIPOLAN LB-840 (product name), manufactured by Lion Specialty Chemicals Co., Ltd., liquid having a moisture content of 65% by mass).

D-2: Coconut alcohol EO 15 mol adduct (LEOX CC-150 (product name), manufactured by Lion Specialty Chemicals Co., Ltd., moisture content of 0% by mass.

### Component (E)

E-1: Polyvinyl alcohol (PVA-405 (product name), manufactured by Kuraray Co., Ltd., degree of saponification: 80.0 to 83.0 mmol %, viscosity (4% aqueous solution, 20° C.): 4.5 to 5.2 mPa·s).

E-2: Hydroxypropyl methylcellulose (METOLOSE 60SH50 (product name), manufactured by Shin-Etsu Chemical Co., Ltd., degree of methoxy group substitution: 1.8, hydroxypropoxy group substitution moles: 0.25, viscosity (2% aqueous solution, 20° C.): 50 mPa·s).

### Examples 1 to 10

Examples 1 to 10 correspond to the examples of the present invention.

Components (A) to (D) and water of the composition shown in Table 1 were mixed with a high-speed stirring granulator (high-speed mixer, manufactured by Earth Technica Co., Ltd.) to produce an anti-tack agent in the form of granules.

The results of measuring the average particle size by the sieving method mentioned above are shown in the table.

The angle of repose of each of the granular anti-tack agents according to Examples 1 to 10 was in the range of 70 to 90°.

### Examples 11 to 15

Examples 11 to 12 correspond to the examples of the present invention and Example 15 corresponds to the comparative example.

Components (A) to (D) and water of the composition shown in Table 2 were mixed with a ribbon type mixer (manufactured by Fuji Paudal Co., Ltd.) to produce an anti-tack agent in the form of powder.

The results of measuring the average particle size by the laser diffraction method mentioned above are shown in the table.

The average particle size of Example 15 could not be measured since there were many lumps having an excessive amount of moisture. Therefore, it is marked as “-”.

The angle of repose of each of the powdery anti-tack agents according to Examples 11 to 15 was in the range of 70 to 90°.

### Examples 16 to 20

Examples 16 to 19 correspond to the examples of the present invention and Example 20 corresponds to the comparative example.

Components (A) to (D) and water of the composition shown in Table 2 were molded into a cylindrical shape having a diameter (minor axis) of 5 mm by means of a pelletizer (product name; Disc Pelleter F-15, manufactured by Dalton Corporation), and cut into a size having a length (major axis) of 5 mm, 10 mm, or 15 mm to produce an anti-tack agent in the form of pellets.

The minor axis×major axis of the pellets is shown in the table.

The angle of repose of each of the anti-tack agents in the form of pellets according to Examples 16 to 20 was in the range of 70 to 90°.

### Examples 21 to 24

Examples 21 to 24 correspond to the examples of the present invention.

Components (B) to (E) and water of the compositions shown in Table 3 were mixed with a ribbon mixer (manufactured by Fuji Paudal Co., Ltd.) to produce powdery anti-tack agents.

The results of measuring the average particle size by the laser diffraction method described above are shown in the table.

The angle of repose of each of the powdery anti-tack agents of Examples 21 to 24 was in the range of 70 to 90°.

In the tables, A/(A+B) indicates a ratio of the component (A) with respect to the total of the component (A) and the component (B). E/(B+E) indicates a ratio of the component (E) with respect to the total of the component (B) and the component (E).

The results of measuring the moisture content of the anti-tack agent of each of the examples by the method mentioned above are shown in the table.

With respect to the anti-tack agent of each example, the results of evaluation of the suppression property of solidification, the solubility, and the anti-tack property by the method described above are shown in the tables.

In the tables, a blank means that the blending component is not blended.

TABLE 1

| | | | Exam- | Exam- | Exam- | Exam- | Exam- | Exam- | Exam- | Exam- | Exam- | Exam- |
|---|---|---|---|---|---|---|---|---|---|---|---|---|
| | | | ple 1 | ple 2 | ple 3 | ple 4 | ple 5 | ple 6 | ple 7 | ple 8 | ple 9 | ple 10 |
| Composition | (A) | A-1 | 35 | 35 | 35 | 35 | 35 | 55 | 20 | 20 | 35 | 75 |
| [parts by mass] | (B) | B-1 | 40 | 40 | 40 | 40 | | 20 | 54 | 54 | 40 | |
| | | B-2 | | | | | 40 | | | | | |
| | | B-3 | 10 | 10 | 10 | 10 | 10 | 10 | 10 | 10 | 10 | |
| | | B-4 | 5 | 5 | 5 | 5 | 5 | 5 | 5 | 5 | 5 | 5 |
| | (C) | C-1 | | | | | | | 1 | | | |
| | | C-2 | | | | | | | | 1 | | |
| | (D) | D-1 | 3 | 3 | 3 | 3 | 3 | 3 | 3 | 3 | 3 | 3 |
| | | D-2 | 7 | 7 | 7 | 7 | 7 | 7 | 7 | 7 | 7 | 7 |
| | Water | | 10 | 25 | 25 | 25 | 25 | 25 | 25 | 25 | 25 | 25 |
| Ratio of A/(A + B) [% by mass] | | | 38.9 | 38.9 | 38.9 | 38.9 | 38.9 | 61.1 | 22.5 | 22.5 | 38.9 | 93.8 |
| Moisture content [% by mass] | | | 13.7 | 28.7 | 28.7 | 28.7 | 28.7 | 29.7 | 28 | 28 | 28.7 | 30.7 |
| Form | | | Granules | | | | | | | | | |
| Average particle size [mm] or | | | 0.2 | 0.2 | 1 | 3 | 3 | 3 | 3 | 3 | 5 | 3 |
| Minor axis [mm] × major axis | | | | | | | | | | | | |
| [mm] | | | | | | | | | | | | |
| Evaluation | Suppression of | Maximum | 0.5 | 1 | 1 | 1.3 | 1.3 | 1.3 | 1.3 | 1.3 | 1.5 | 1.3 |
| | solidification | load [kg] | | | | | | | | | | |
| | Solubility | Dissolution | 40 | 30 | 30 | 35 | 35 | 45 | 25 | 25 | 45 | 60 |
| | | period of | | | | | | | | | | |
| | | time [min] | | | | | | | | | | |
| | Anti-tack | Peeling | 1.2 | 1.2 | 1.2 | 1.2 | 1.2 | 0.9 | 1.2 | 1.2 | 1.2 | 0.8 |
| | property | resistance | | | | | | | | | | |
| | | [N/cm] | | | | | | | | | | |

TABLE 2

| | | | Exam- | Exam- | Exam- | Exam- | Exam- | Exam- | Exam- | Exam- | Exam- | Exam- |
|---|---|---|---|---|---|---|---|---|---|---|---|---|
| | | | ple 11 | ple 12 | ple 13 | ple 14 | ple 15 | ple 16 | ple 17 | ple 18 | ple 19 | ple 20 |
| Composition | (A) | A-1 | 35 | 35 | 35 | 35 | 35 | 35 | 35 | 35 | 35 | 35 |
| [parts by mass] | (B) | B-1 | 40 | 40 | 40 | 40 | 40 | 40 | 40 | 40 | 40 | 40 |
| | | B-2 | | | | | | | | | | |
| | | B-3 | 10 | 10 | 10 | 10 | 10 | 10 | 10 | 10 | 10 | 10 |
| | | B-4 | 5 | 5 | 5 | 5 | 5 | 5 | 5 | 5 | 5 | 5 |
| | (C) | C-1 | | | | | | | | | | |
| | | C-2 | | | | | | | | | | |
| | (D) | D-1 | 3 | 3 | 3 | 3 | 3 | 3 | 3 | 3 | 3 | 3 |
| | | D-2 | 7 | 7 | 7 | 7 | 7 | 7 | 7 | 7 | 7 | 7 |
| | Water | | 0 | 10 | 20 | 25 | 35 | 10 | 25 | 25 | 25 | 35 |
| Ratio of A/(A + B) [% by mass] | | | 38.9 | 38.9 | 38.9 | 38.9 | 38.9 | 38.9 | 38.9 | 38.9 | 38.9 | 38.9 |
| Moisture content [% by mass] | | | 3.7 | 13.7 | 23.7 | 28.7 | 38.7 | 13.7 | 28.7 | 28.7 | 28.7 | 38.7 |
| Form | | | Powder | | | | | Pellets | | | | |
| Average particle size [mm] or | | | 0.05 | 0.05 | 0.07 | 0.08 | — | 5 × 5 | 5 × 5 | 5 × 10 | 5 × 15 | 5 × 5 |
| Minor axis [mm] × major axis | | | | | | | | | | | | |
| [mm] | | | | | | | | | | | | |
| Evaluation | Suppression | Maximum | <0.1 | 0.3 | 0.5 | 0.8 | 2.5 | 1 | 1.2 | 1.2 | 1.2 | 2.2 |
| | property of | load [kg] | | | | | | | | | | |
| | solidification | | | | | | | | | | | |
| | Solubility | Dissolution | 60 | 50 | 40 | 40 | 30 | 55 | 50 | 55 | 60 | 65 |
| | | period of | | | | | | | | | | |
| | | time [min] | | | | | | | | | | |
| | Anti-tack | Peeling | 1.2 | 1.2 | 1.2 | 1.2 | 2.2 | 1.2 | 1.2 | 1.2 | 1.2 | 2.8 |
| | property | resistance | | | | | | | | | | |
| | | [N/cm] | | | | | | | | | | |

TABLE 3

| | | | Example 21 | Example 22 | Example 23 | Example 24 |
|---|---|---|---|---|---|---|
| Composition | (A) | A-1 | | | | |
| [parts by mass] | (B) | B-1 | 75 | | | |
| | | B-2 | | 60 | | |
| | | B-3 | | 20 | | |
| | | B-4 | 5 | | 30 | 30 |
| | (C) | C-1 | | | | |
| | | C-2 | | | | |
| | (D) | D-1 | 3 | 3 | 10 | 10 |
| | | D-2 | 7 | 7 | 20 | 20 |
| | (E) | E-1 | 3 | | 30 | |
| | | E-2 | | 5 | | 30 |
| | Water | | 7 | 5 | 7 | 7 |
| Ratio of E/(B + E) [% by mass] | | | 3.6 | 5.9 | 50.0 | 50.0 |
| Moisture content [% by mass] | | | 7 | 5 | 7 | 7 |
| Form | | | Powder | | | |
| Average particle size [mm] or | | | 0.5 | 0.3 | 1 | 1 |
| Minor axis [mm] × major axis [mm] | | | | | | |
| Evaluation | Suppression property of | Maximum load [kg] | 0.1 | 0.3 | 0.5 | 0.5 |
| | solidification | | | | | |
| | Solubility | Dissolution period of | 60 | 60 | 60 | 60 |
| | | time [min] | | | | |
| | Anti-tack property | Peeling resistance | 0.7 | 0.6 | 0.3 | 0.3 |
| | | [N/cm] | | | | |

As shown in Tables 1, 2, and 3, the anti-tack agents of Examples 1 to 14, Examples 16 to 19, and Examples 21 to 24 having a moisture content of more than 3% by mass to 35% by mass exhibit superior suppression of solidification.

### INDUSTRIAL APPLICABILITY

An anti-tack liquid is produced using a method of quantitatively mixing the anti-tack agent for unvulcanized rubber of the present invention and water. The anti-tack agent is adhered to the surface of unvulcanized rubber to prevent mutual adhesion of the unvulcanized rubber.

### DESCRIPTION OF SYMBOLS

1, 50, and 60 Anti-tack liquid production device
   Anti-tack treatment device
   3 Control device
   11 Hopper
   11a Opening part
   11b Lid
   11c Discharge port
   11d Guide
   12 Quantitative feeder
   13 Stirring tank
   14 Pipe
   14a Electromagnetic valve
   15 Stirring device
   16 Float sensor
   17 Conductivity sensor
   18 Water supply pipe
   18a Electromagnetic valve
   19 Pump
   20 Anti-tack liquid adhesion part
21 and 24 Conveyor
   22 Immersion tank
   23 Spraying device
   25 Stock tank
   26 Pipe
   27 Concentration sensor
   28 Level gauge
   30 Drying part
   31 Dryer
   41 Rubber extruder
   42 Storage part
   51 Hopper container (hopper)
   51a Opening part
   51b Lid
   51c Discharge port
   51d Cone valve (open/close valve)
   51e Lower part of body part
   52 Discharge device (quantitative feeder)
   52a Probe
   52b Discharge hopper
   54 Static mixer (Dispersion-assisting device)
   55 Circulation channel
   55a Electromagnetic valve
   61 Supply tank
   62 Supply pipe
   62a Electromagnetic valve
   G Anti-tack agent
   Q1 Anti-tack liquid (Anti-tack liquid production device)
   Q2 Anti-tack liquid (Anti-tack treatment device)
   S1 Unvulcanized rubber sheet
   S2 Unvulcanized rubber sheet to which an anti-tack liquid is adhered
   S3 Unvulcanized rubber sheet which has been subjected to an anti-tack treatment

1. An anti-tack agent for unvulcanized rubber in the form of a solid, having a moisture content that is more than 3% by mass but is 35% by mass or less, and comprising: at least one of the following component (A) and the following component (E); and the following component (B),
(A) a smectite,
(B) at least one material selected from the group consisting of inorganic silicates other than the smectite, metal oxides, metal hydroxides, calcium carbonate, red iron oxide, carbon black, graphite, and metallic soaps, and
(E) a water-soluble polymer exhibiting a film-forming ability.

2. The anti-tack agent for unvulcanized rubber according to claim 1, which is in the form of a powder, a granule, or a pellet.

3. The anti-tack agent for unvulcanized rubber according to claim 1, wherein a total of said component (A) and said component (E) is in a range of from 2% by mass to 100% by mass with respect to a total of said component (A), said component (E), and said component (B).

4. The anti-tack agent for unvulcanized rubber according to claim 1, which comprises two or more types of compositions and has a total moisture content that is more than 3% by mass but is 35% by mass or less.

5. The anti-tack agent for unvulcanized rubber according to claim 4, which comprises two or more types of compositions, in which each composition has a moisture content that is more than 3% by mass but is 35% by mass or less.

6. The anti-tack agent for unvulcanized rubber according to claim 1, which is for use in a device for producing an anti-tack liquid, the device comprising: a hopper for storing a part or all parts of an anti-tack agent for unvulcanized rubber; a stirring tank for mixing said anti-tack agent for unvulcanized rubber and water; and a quantitative feeder for supplying a constant amount of said anti-tack agent in said hopper to said stirring tank.

7. An anti-tack agent for unvulcanized rubber stored in a container having the anti-tack agent for unvulcanized rubber as recited in claim 1, and a container containing the anti-tack agent for unvulcanized rubber.

8. The anti-tack agent for unvulcanized rubber stored in a container according to claim 7, wherein the container is a hopper-type container which has an opening part at an upper part, a discharge port at a bottom part, and a body part at least a lower portion of which has a gradually reduced diameter toward the discharge port

9. A method for producing an anti-tack liquid using a device for producing an anti-tack liquid, provided with a hopper for storing a part or all parts of an anti-tack agent for unvulcanized rubber, a stirring tank for mixing the anti-tack agent for unvulcanized rubber and water, and a quantitative feeder for supplying a constant amount of the anti-tack agent in said hopper to the stirring tank, wherein as said anti-tack agent for unvulcanized rubber, the anti-tack agent for unvulcanized rubber as recited in claim 1 is used.

10. A device for producing an anti-tack liquid, comprising: a hopper provided with an opening/closing valve at a discharge port at a bottom part thereof, which stores a part or all parts of the anti-tack agent for unvulcanized rubber; a quantitative feeder provided with a controlling means for controlling said opening/closing valve; and a stirring tank for mixing the anti-tack agent for unvulcanized rubber and water.

11. A device for producing an anti-tack liquid, comprising: a hopper provided with a cone valve which stores a part or all parts of the anti-tack agent for unvulcanized rubber; a quantitative feeder provided with a lifting/lowering means for lifting or lowering the cone valve; and a stirring tank for mixing the anti-tack agent for unvulcanized rubber and water.

12. The device for producing an anti-tack liquid according to claim 10, which further comprises: a supply tank for storing a liquid containing a part of said anti-tack agent for unvulcanized rubber; and a supply means for quantitatively supplying the liquid from the supply tank to the stirring tank, wherein said hopper stores a part of the remaining part or all parts of the anti-tack agent for unvulcanized rubber.

13. The device for producing an anti-tack liquid according to claim 10, which further comprises a dispersion-assisting device and a circulation channel for taking out a part of the liquid in the stirring tank and supplying the liquid to the stirring tank again through said dispersion-assisting device.

14. The device for producing an anti-tack liquid according to claim 10, which further comprises: a supply tank for storing a liquid containing a part of said anti-tack agent for unvulcanized rubber; a supply means for quantitatively supplying the liquid from the supply tank to the stirring tank; a dispersion-assisting device; and a circulation channel for taking out a part of the liquid in the stirring tank and supplying the liquid to the stirring tank again through said dispersion-assisting device, wherein said hopper stores a part of the remaining part or all parts of the anti-tack agent for unvulcanized rubber.

15. The device for producing an anti-tack liquid according to claim 11, which further comprises: a supply tank for storing a liquid containing a part of said anti-tack agent for unvulcanized rubber; and a supply means for quantitatively supplying the liquid from the supply tank to the stirring tank, wherein said hopper stores a part of the remaining part or all parts of the anti-tack agent for unvulcanized rubber.

16. The device for producing an anti-tack liquid according to claims 11, which further comprises a dispersion-assisting device and a circulation channel for taking out a part of the liquid in the stirring tank and supplying the liquid to the stirring tank again through said dispersion-assisting device.

17. The device for producing an anti-tack liquid according to claim 11, which further comprises: a supply tank for storing a liquid containing a part of said anti-tack agent for unvulcanized rubber; a supply means for quantitatively supplying the liquid from the supply tank to the stirring tank; a dispersion-assisting device; and a circulation channel for taking out a part of the liquid in the stirring tank and supplying the liquid to the stirring tank again through said dispersion-assisting device, wherein said hopper stores a part of the remaining part or all parts of the anti-tack agent for unvulcanized rubber.
